(19) United States
(12) Patent Application Publication
(10) Pub. No.: US 2007/0022043 A1
(43) Pub. Date: Jan. 25, 2007

(54) Trade aggregation system

(76) Inventors: Mark Jeremy Melville Naylor, Tadworth (GB); Alfred Neil Fletcher, London (GB); Harry Justin Barman, Richmond (GB)

Correspondence Address: JOHN F. LETCHFORD, ARCHER & GREINER, P.C., ONE CENENNIAL SQUARE, HADDONFIELD, NJ, 08033, US

(21) Appl. No.: 11/529,018

(22) Filed: Sep. 27, 2006

Related U.S. Application Data
(63) Continuation of application No. 09/823,345, filed on Mar. 30, 2001, now abandoned.

(51) Int. Cl. G06Q 40/00

(52) U.S. Cl. 705/37

(57) ABSTRACT

A system whereby high volumes of related commodities or securities trades with a brokerage firm's clients may be processed by the firm's back office systems. The system includes a firm account processor and a wash account processor which combine all characteristically similar trades with the same counterparty into a discrete aggregate trades. The firm and wash account processor calculates the quantity and proceeds of the aggregate trades from the sum of the quantities and proceeds of characteristically similar related trades which make up the aggregate trades. The prices of the aggregate trades are computed as the average price of all of their related trades. The wash account processor transmits information concerning any aggregate trades and unaggregated trades to the firm's back office systems for settlement as individual trades with each individual counterparty.

### CROSS-REFERENCE TO RELATED APPLICATION

This application is a Continuation of U.S. patent application Ser. No. 09/823,345 filed Mar. 30, 2001.

### FIELD OF THE INVENTION

The present invention relates in general to commodities and securities trading systems and, in particular, to a system for efficiently aggregating and processing trades having similar transactional characteristics.

### BACKGROUND OF THE INVENTION

A typical commodities or securities trade represents an agreement between a brokerage firm and a counterparty. The particular part of the firm involved in the trade is represented by an internal account number or firm account. The counterparty involved is similarly represented by an external counterparty account number or broker account. Brokerage firms, especially retail brokerages, deal with many clients that may make many related and unrelated transactions on a yearly, monthly, weekly, daily or even hourly basis. Under these circumstances, a large brokerage firm may be charged with processing and settling potentially vast numbers of trades on a continuous basis. In many cases, the firm enlists the services of external settlement agencies to assist in settling the transactions.

At present, individual trades are settled individually between the firm's back office and the appropriate counterparties. A disadvantage of prior approaches is that as the number of firm accounts increases, so does the number of trades or executions that need to be sent through back office systems and to be settled with external counterparties. Increased trade volume, in turn, necessitates increased capacity in human, equipment and other resources in order to process and settle the transactions.

Firm accounts frequently make trades having similar transactional attributes, e.g., trades in the same commodities or securities, with the same trade and settle dates, and of the same type (such as buy or sell). Heretofore, each of these transactions has been individually processed and settled. What has thus far gone unrecognized is that trades having similar transactional characteristics can be aggregated for each counterparty, and that aggregating these trades could result in substantial benefits being realized by the firm and the counterparties.

An advantage exists, therefore, for methods and apparatus by which high volumes of commodities or securities trades can be efficiently processed and settled between a firm and its counterparties without placing significant burdens upon the firm's back office systems as the number of firm accounts and transactions with those accounts increases.

### SUMMARY OF THE INVENTION

The present invention provides a system whereby high volumes of related commodities or securities trades with firm accounts may be processed by a trading firm's back office systems without imposing substantial additional burdens upon the firm's personnel and equipment.

The present system involves conversion of a single trade into two trades, i.e., each trade between a firm account and a counterparty account is first turned into two trades. One of these two trades is a purely internal trade between the firm account and another internal account, hereinafter referred to as “wash account.” The other trade that is generated is between the wash account and the counterparty account.

The system includes a firm account processor and a wash account processor which sequentially combine all trades with the same counterparty in the same commodities or securities, with the same trade and settle dates, and of the same type (e.g., buy or sell) into “aggregate trades.” The trades that are used to create the aggregate trades may be referred to as “related trades.” The firm and wash account processors also copy any other relevant attributes of the aggregate trades from a related trade (since they will be the same for all related trades) and calculate the quantity and proceeds of the aggregate trades from the sum of the quantities and proceeds of the related trades. The price of the aggregate trade is computed by the wash account processor as the average price of all of the related trades. Finally, the wash account processor transmits information concerning aggregate trades and unaggregated trades to the firm's back office systems for settlement as single trades with each individual counterparty.

Among its many advantages, trade aggregation as proposed herein reduces the number of trades or executions that must be sent through back office systems and settled with external counterparties.

Additionally, the number of actual trades that can flow through back office systems may be increased without having to increase capacity of those systems. Reducing the number of trades that need to be processed and settled in turn reduces per trade settlement costs levied by the brokerage firm or external settlement agencies.

Moreover, the instant system presents a “one stop shopping” view to clients. Regardless of how the trades are booked internally by the firm, a counterparty will only see a minimum set of trades that encompass the business it has conducted with the firm.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments shown, by way of example only, in the accompanying drawings wherein:

FIG. 1 is a schematic representation of the manner in which securities trades between a brokerage firm and a counterparty are conventionally processed and settled;

FIG. 2 is a schematic representation of the manner in which securities trades between a brokerage firm and multiple counterparties are processed and settled according to the present invention; and

FIG. 3 is a schematic representation of a computerized system for processing and settling securities trades between a brokerage firm and a counterparty in accordance with FIG. 2.

### DETAILED DESCRIPTION OF THE INVENTION

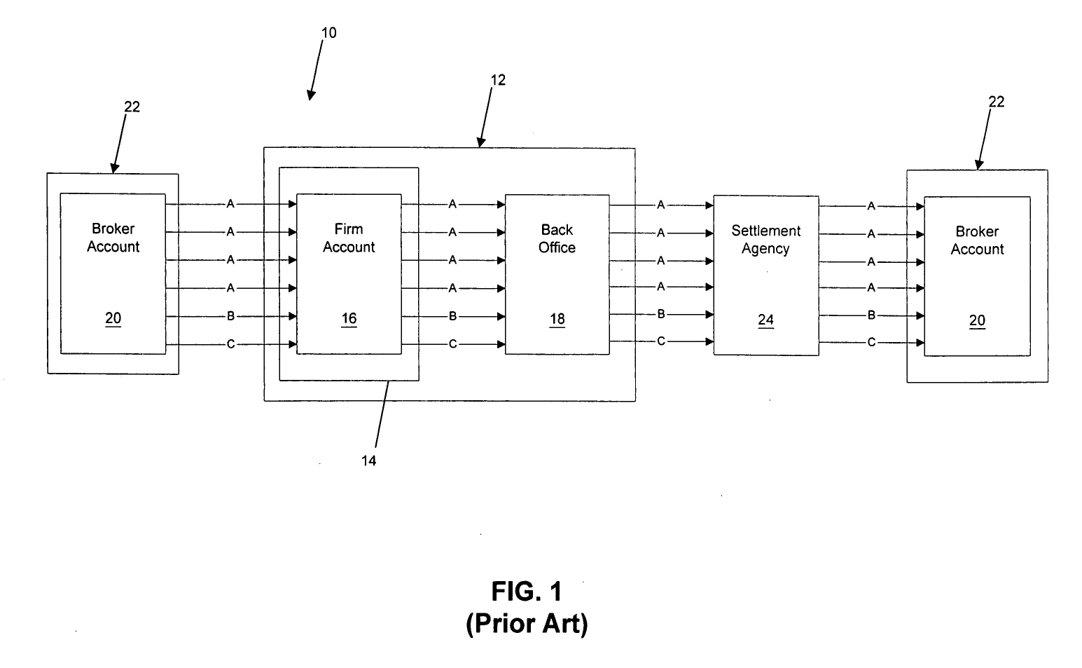

Referring to the drawings wherein like or similar references indicate like or similar elements throughout the several views, there is shown in FIG.1 a conventional system for executing trades in commodities or securities. The system, generally identified by reference numeral 10, includes a brokerage firm 12 comprising a front office 14 which processes securities trades executed by a plurality of firm accounts 16 (only one of which is shown in FIG. 1 for simplicity of illustration) and a back office 18 which settles trades that are executed by the firm accounts 16. Front office 14 transacts business through a particular firm account 16 with a corresponding external counterparty account or broker account 20 of a counterparty 22 (wherein both of which numerals 22 in FIG. 1 refer to the same counterparty). More specifically, counterparty 22 executes trades, such as purchases or sales of commodities or securities, with its corresponding firm account 16 of front office 14 through broker account 20. Such trades are represented graphically by the letters A, B and C. For clarity of description, it will be understood that the essential characteristics or attributes of trades A are similar to one another and are different from the essential characteristics or attributes of trades B and C. That is, all of trades A are with the same counterparty in the same commodities or securities, with the same trade and settle dates, and of the same type (e.g., buy or sell). For example, each of the trades A may be sales of XYZ Corporation stock having the same trade and settle dates and in the amount of 1000, 2000 and 3000 shares, respectively. Transactions B and C may vary in character from transactions A and from each other in one or more of differing commodities or securities, trade and/or settlement dates or whether they are sells versus buys (or buys versus sells).

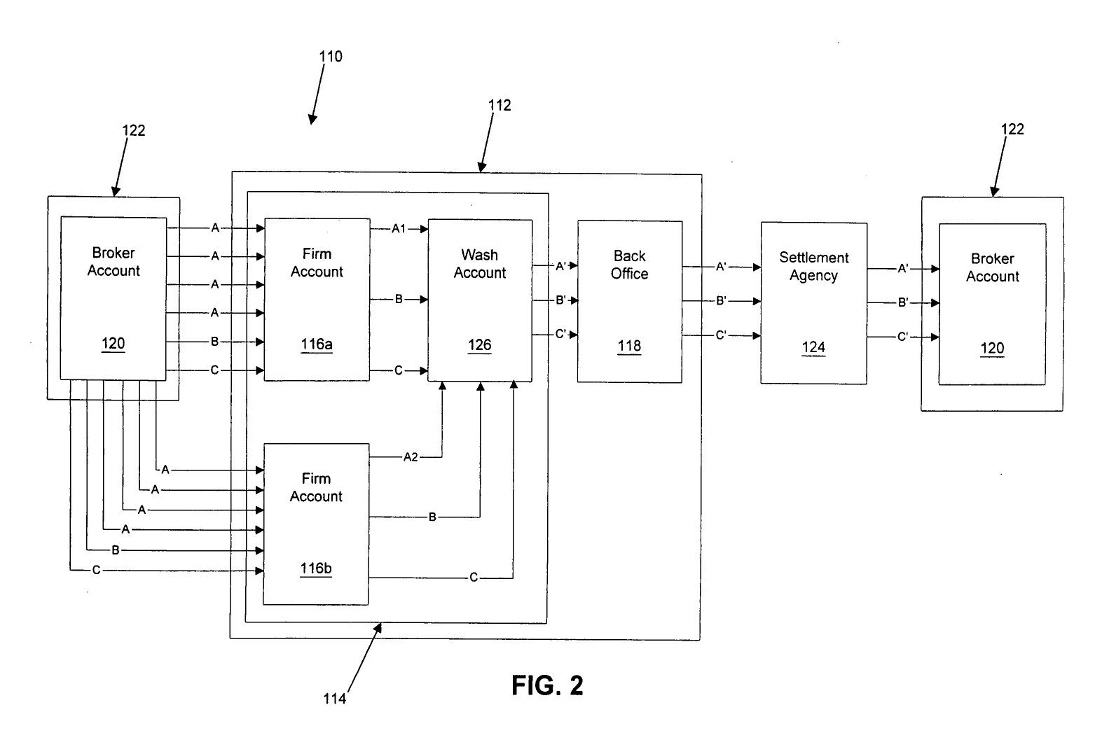

FIG. 1 reveals that each of trades A, B and C are directed to the back office 18 where they are individually settled with the counterparty 22 broker account 20 either directly by the back office or, as shown, through an optional external settlement agency 24. In the illustrated example, trades A, B and C constitute six total trades: four of trades A and one each of trades B and C. Whether they are settled by the back office 18 or by external settlement agency 24, a transaction charge is normally attached to each settlement, whereby a total of six settlement charges may be levied upon the broker account 20. As will be appreciated by contrast with the present invention as depicted in FIG. 2, the trade management system of FIG. 1 results in inefficient use of the resources of back office 18 and maximizes the number of settled transactions and associated settlement fees that must be paid by counterparty 22.

Referring to FIG. 2, there is shown a system for executing trades in commodities or securities in accordance with the present invention. The system, generally identified by reference numeral 110, includes a brokerage firm 112 comprising a front office 114 which processes securities trades executed by a plurality of firm accounts. For simplicity of illustration, only two firm accounts 116a, 116b are shown in FIG. 2. It will be understood, however, that front office 114 may process trades from several hundred or even several thousand firm accounts. Brokerage firm 112 further includes a back office 118 which settles trades that are executed by the firm accounts 116. Front office 114 transacts business through a particular firm account 116a, 116b. . . 116n with a corresponding external counterparty account or broker account 120 of a particular counterparty 122 (wherein both of which numerals 122 in FIG. 2 are in reference to the same counterparty). Through broker account 120, counterparty 122 executes trades, such as purchases or sales of commodities or securities, with its corresponding firm account 116a, 116b. . . 116n of front office 114.

Front office 114 of FIG. 2 differs from front office 14 of FIG. 1 by virtue of its representation of the concept by which trades having similar characteristics or attributes may be aggregated to produce the many benefits of the present invention. As in the previous example, for each firm account 116a, 116b, and so on, a total of six trades are conducted between the respective firm account and the broker account 120: four of trades A and one each of trades B and C. Again, all of the aforementioned essential characteristics or attributes of trades A are similar to one another and are different in one or more respects from the essential characteristics or attributes of trades B and C.

The present invention involves conversion of a single trade into two trades, i.e., each trade between a firm account 116a, 116b. . . 116n and a counterparty or broker account 120 is turned into two trades. One of these two trades is a purely internal trade between the respective firm account 116a, 116b. . . 116n and another internal account, wash account 126. The other trade that is generated is between the wash account 126 and the broker account 116 through back office 118 (and, optionally, external settlement agency 124).

All of trades A associated with each firm account 116a, 116b. . . 116n which are with the same counterparty 122 and in the same commodities or securities, i.e., with the same trade and settle dates, and of the same type (e.g., buy or sell), are combined into firm account aggregate trades, A1 for firm account 116a, A2 for firm account 116b, and so forth. The individual trades that are used to create an aggregate trade may be referred to as “related trades.” Other attributes of the firm account aggregate trades are copied by the respective firm accounts 116a, 116b. . . 116n from a related trade (since they will be the same for all related trades). The quantity and proceeds of firm account aggregate trades A1, A2 . . . An are computed from the sum of the quantities and proceeds of related trades A processed by the firm accounts.

In wash account 126, all of firm account aggregate trades A1, A2 . . . An, and previously unaggregated trades, i.e., trades B and trades C, which are with the same counterparty in the same commodities or securities, with the same trade and settle dates, and of the same type (e.g., buy or sell) are combined, where appropriate, into one or more wash account aggregate trades which are graphically represented by A′, B′ and C′. The prices of the wash account aggregate trades A′, B′ and C′ are computed as the average price of all of their respective related trades. Finally, along with any unaggregated trades (not illustrated), wash account aggregate trades A′, B′ and C′ flow to the firm's back office systems 118 and thence for settlement as single trades with appropriate counterparty 122.

As used herein the phrase “average price” of all related trades shall be construed to mean the volume weighted average price of all related trades with the same counterparty account. Stated mathematically, the Average Price of All Related Trades=Sum of the Proceeds of All Related Trades/Sum of the Quantities of Shares Traded in All Related Trades. The following example is illustrative: Assume a first trade by a counterparty account in certain securities, Trade 1, involves a purchase of 100 shares at a price of $10 per share, and a second trade by the same counterparty account, Trade 2, involves a purchase of one share of the same securities at a price of $20. Under these circumstances, the average price of the related trades in the securities would be (1000×10+1×20)(1000+1)=$10.00999.

Consequently, whereas existing trade management systems (FIG. 1) must process and settle each and every characteristically similar and dissimilar trade between each firm account and each broker account as separate trades, the present system aggregates characteristically similar trades for settlement, thereby reducing the number of trades or executions that must be sent through back office systems and settled with external counterparties. As a result, the number of actual trades that can flow through back office systems may be increased without having to increase capacity of those systems. Reducing the number of trades that need to be processed and settled in turn reduces settlement costs to the counterparty clients. Moreover, in circumstances where aggregate trades are involved, the instant system presents a less cluttered back end view to clients than existing systems. That is to say, regardless of how the trades are booked internally by the brokerage firm, a counterparty will be presented with a set of settled trades that may be considerably less in number than were originally requested by the counterparty.

The invention may be practiced using any conventional computer systems capable of conveying transactional information between the firm and its counterparties. However, such systems must be appropriately configured to include a wash account and perform the internal aggregate trade processing steps proposed herein.

Some portions of the following discussion are expressed in terms of generalized system components and operations that occur on data bits within a computer memory. These descriptions and representations are the means commonly used by those skilled in the data processing arts to convey the substance of their work to others skilled in the art. It should be borne in mind, however, that all of these and similar terms are to be associated with the appropriate physical components and operations and are merely convenient labels applied to these items.

Additionally, the discussion describes in detail only those portions of the system that are necessary to provide the reader with a proper understanding of the invention and its novel aspects. It will be understood that customary telecommunications equipment and computer hardware and software necessary to support such a system such as wired or wireless telecommunications infrastructure, computer microprocessors, input/output (I/O) devices, memory, databases, servers, operating systems, web browsers, and so forth, are well known and documented and, therefore, will not be discussed herein.

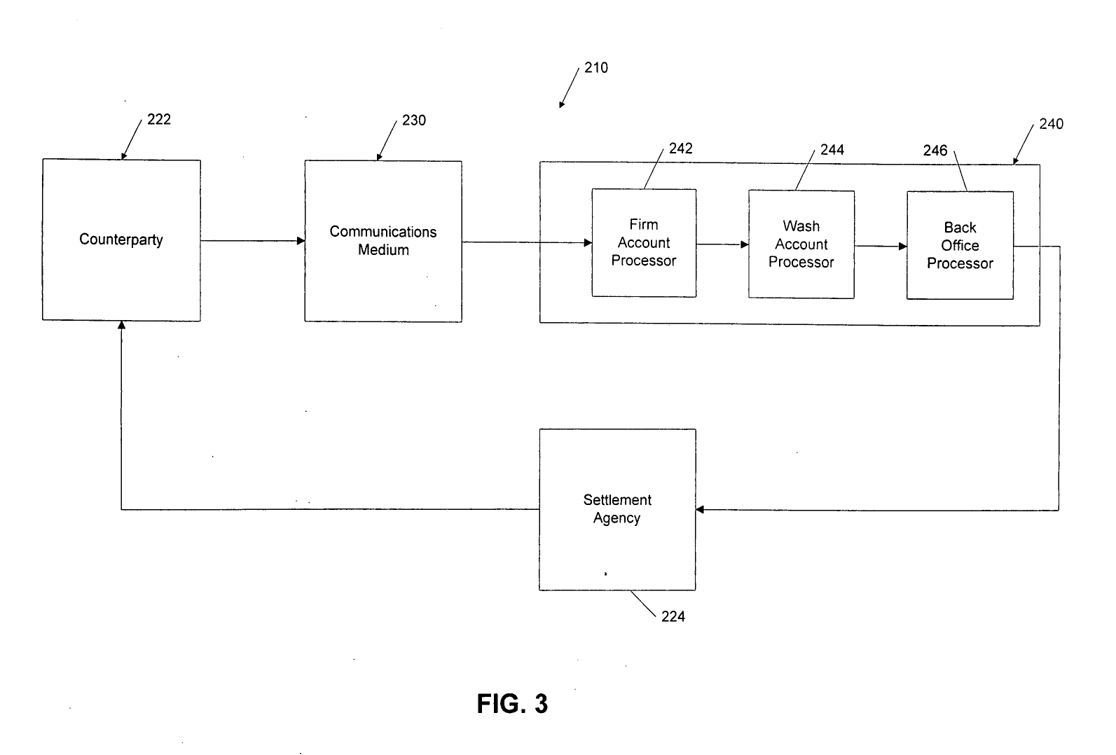

Referring to FIG. 3, there is shown a system 210, which may be wholly or partially automated in operation, for supporting the trade aggregation method and system 110 depicted in FIG. 2. In FIG. 3, a counterparty 222 with a broker account communicates a desire to make a trade using an unillustrated communications device such as a conventional telephone, a keyboard and monitor, or a wireless access device such as a personal digital assistant and stylus or telephone and keypad, through a suitable wired or wireless telecommunications medium 230 to a brokerage firm at which the trade request is received and processed by a computer 240. Depending upon the telecommunications medium 230, the trade request may be automatically input into computer 240 or it may be manually input by a human operator.

Computer 240 comprises at least one firm account processor 242 at which the counterparty's broker account number and any other necessary bibliographic information, as well as parameters of the trade requests, are initially received and verified. Upon confirmation of the counterparty trade request information, firm account processor 242 aggregates any characteristically similar trades into firm account aggregate trades as described above. The firm account processor 242 then conveys information concerning the firm account aggregate trades and any unaggregated trades to a wash account processor 244. The wash account processor examines the content of the information to determine if any of the trades would qualify as related trades that may be aggregated with other similar trade requests that have been previously made by the counterparty. For instance, wash account processor 244 may determine whether the trade request is in the same commodities or securities, with the same trade and settle dates, and of the same type (e.g., buy or sell) as other requests that have been made by the counterparty. If the trade request is found to be characteristically similar to one or more previous trade requests then the similar trades are identified by the wash account processor 244 as related trades and are combined into discrete wash account aggregate trades. The wash account processor 244 also copies from a related trade any other attributes of the aggregate trade that the firm deems relevant (since they will be the same for all related trades) and computes the quantity and proceeds of the wash account aggregate trades from the sum of the quantities and proceeds of the related trades. The price of the aggregate trade is computed as the average price of all of the related trades. Finally, the wash account processor 244 transmits the pertinent information regarding wash account aggregate and unaggregated trades to a back office processor 246 that may generate, either automatically or with human intervention, any necessary paper and/or electronic documentation that may be needed for settling any aggregated or unaggregated trades with counterparty 222. The trades may thereafter be settled either directly by the firm's back office systems and personnel or through an external settlement agency 224.

In a fully automated embodiment, computer or server 240 is preferably configured with appropriate proprietary or commercially available software suitable to enable direct interaction with a counterparty 222. Preferably, system 210 is highly scalable, whereby any number of counterparties may be readily connected to and simultaneously participate in the system. Further, the system architecture may be portable and capable of being run on a variety of software systems such as Windows ®, UNIXO®, etc.

System 210 may comprise a flexible and adaptable client-server architecture that employs any suitable object-oriented programming language such as, for example, JAVA® or C++. And, the system may operate on any electronic communication network capable of enabling interactive participation by users of the system. Examples of communication networks that may support system include the Internet, a proprietary network, a local or wide area network, a wireless network, a telephone network, etc. By way of illustration but not limitation, the system may be a World Wide Web (Web) based system functioning on the Internet.

The system further includes a communication network services integrator appropriate for the communication network within which the system is implemented. For example, in a Web based environment, a suitable communication network services integrator may be the user interface, program logic, data and Web server applications marketed by Oracle Corp. of Redwood Shores, Calif.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A method of managing commodities or securities trades between a counterparty and a brokerage firm, said method comprising the steps of:
(a) processing a plurality of trades between said counterparty and said firm;
(b) identifying trades processed in step (a) that have similar characteristics as related trades;
(c) combining said related trades into at least one aggregate trade; and
(d) settling each of said at least one aggregate trade as a single trade with said counterparty.

2. The method of claim 1 further comprising the step of establishing at least one firm account corresponding to at least one counterparty account of a counterparty and performing step (b) using said firm account.

3. The method of claim 2 further comprising the step of establishing a wash account for receiving aggregate trades and unaggregated trades from said at least one firm account and performing step (b) using said wash account.

4. The method of claim 1 further comprising the step of settling trades having characteristics different from said related trades as individual trades with said counterparty.

5. The method of claim 1 wherein said similar characteristics include trades in the same commodities or securities, with the same trade and settle dates, and of the same buy or sell type.

6. The method of claim 1 further comprising the step of calculating the quantity and proceeds of said aggregate trade from the sum of the quantities and proceeds of said related trades, wherein the price of said aggregate trade is computed as the average price of all of said related trades.

7. A computerized system for managing commodities or securities trades between a counterparty and a brokerage firm, said system comprising:
account processor means for processing a plurality of trades between said counterparty and said firm, said processing including identifying trades that have similar characteristics as related trades and combining said related trades into at least one aggregate trade; and
a back office processor for enabling settlement of each of said at least one aggregate trade as a single trade with said counterparty.

8. The system of claim 7 wherein said account processor means comprise:
a firm account processor for processing a plurality of trades between said counterparty and said firm, said processing including identifying trades that have similar characteristics as related trades and combining said related trades into at least one firm account aggregate trade; and
a wash account processor for processing trades received from said firm account processor, said processing including identifying trades that have similar characteristics as related trades and combining said related trades into at least one wash account aggregate trade.

9. The system of claim 8 wherein said firm account processor and said wash account processor additionally identify trades that have characteristics different from said related trades and said back office processor additionally enables settlement of said trades having characteristics different from said related trades as individual trades with said counterparty.

10. The system of claim 7 wherein said similar characteristics include trades in the same commodities or securities, with the same trade and settle dates, and of the same buy or sell type.

11. The system of claim 8 wherein said wash account processor additionally calculates the quantity and proceeds of said aggregate trade from the sum of the quantities and proceeds of said related trades, and the price of said aggregate trade as the average price of all of said related trades.
